(19) United States
(12) Patent Application Publication
(10) Pub. No.: US 2015/0115831 A1
(43) Pub. Date: Apr. 30, 2015

(54) CONVERSION CIRCUIT BETWEEN FLUORESCENT BALLAST AND LED

(71) Applicant: KONINKLIJKE PHILIPS N.V., EINDHOVEN (NL)

(72) Inventors: Haimin Tao, Eindhoven (NL); Peter Deixler, Eindhoven (NL)

(21) Appl. No.: 14/397,562

(22) PCT Filed: Apr. 25, 2013
(86) PCT No.: PCT/IB2013/053263

§ 371 Date: Oct. 28, 2014

Related U.S. Application Data
(60) Provisional application No. 61/641,949, filed on May 3, 2012.

(51) Int. Cl. H05B 33/08; H05B 33/10; F21K 99/00

(52) U.S. Cl. CPC H05B 33/0809; F21K 9/17; H05B 33/10
USPC 315/291; 29/825

(57) ABSTRACT

Conversion circuits (1) convert first signals coming from fluorescent ballasts (101) into second signals for light circuits (2) comprising light emitting diodes to replace discharge lamps (102). The conversion circuits (1) comprise input stages (11) with at least two inputs (21-24, 31-32) for receiving the first signals, output stages (13) with two outputs (71-72) for supplying the second signals, and reactive stages (12) for coupling the input and output stages (11, 13). Such relatively simple conversion circuits (1) are relatively low-cost and relatively robust. The reactive stages (12) comprise reactive circuits and reduce amplitudes of one or more of the first and second signals. The reactive circuits comprise one or more inductors (41, 42) and/or capacitors (43).The conversion circuits (1) may form part of the fluorescent ballasts (101) or may form part of the light circuits (2) or may partly form part of the fluorescent ballasts (101) and may partly form part of the light circuits (2).

### FIELD OF THE INVENTION

The invention relates to a conversion circuit for converting first signals coming from a fluorescent ballast into second signals for feeding a light circuit via a rectifier circuit. The invention further relates to a fluorescent ballast, to a light circuit and to a method.

Examples of such a fluorescent ballast are self-oscillating ballasts and fixed frequency ballasts and chip controlled ballasts. Examples of such a light circuit are light circuits comprising one or more light emitting diodes of whatever kind and in whatever combination. Fluorescent ballasts are designed for feeding discharge lamps. When replacing the discharge lamps by light circuits comprising one or more light emitting diodes, without replacing the fluorescent ballasts, conversion circuits should be introduced between the fluorescent ballasts and the light circuits.

### BACKGROUND OF THE INVENTION

US 2011/0254465 A1 discloses a light emitting diode drive circuit device with a resonant network correction circuit. This resonant network correction circuit has four inputs and four outputs and is coupled to two rectifying circuits and is therefore relatively complex.

### SUMMARY OF THE INVENTION

It is an object of the invention to provide an improved conversion circuit that is relatively simple. Further objects of the invention are to provide a fluorescent ballast, a light circuit and a method.

According to a first aspect, a conversion circuit is provided for converting first signals coming from a fluorescent ballast into second signals for feeding a light circuit via a rectifier circuit, the light circuit comprising at least one light emitting diode, the conversion circuit comprising
an input stage with at least two inputs for receiving the first signals,
an output stage with two outputs for supplying the second signals, and
a reactive stage for coupling the output stage to the input stage.

The input stage comprises for example two, three or four inputs. By having introduced the output stage comprising two outputs and by having introduced the reactive stage that only needs to couple the output stage to the input stage in a reactive way, a relatively simple conversion circuit has been created. Such a relatively simple conversion circuit is relatively low-cost and relatively robust.

A reactive stage that couples an output stage to an input stage in a reactive way introduces a reactive transfer function between the input stage and the output stage. The reactive stage for example detunes a resonant tank in the fluorescent ballast and/or for example sets a value of a current signal flowing through the light circuit.

The rectifier circuit comprises for example one diode, two diodes, or four diodes in a rectifier bridge. The rectifier circuit may form part of (the output stage of) the conversion circuit, in which case the inputs of the rectifier circuit are to be coupled to the reactive stage and in which case the outputs of the rectifier circuit form the outputs of the conversion circuit. Alternatively, the rectifier circuit may be located outside the conversion circuit, in which case the inputs of the rectifier circuit are to be coupled to the outputs of the conversion circuit and in which case the outputs of the rectifier circuit are to be coupled to inputs of the light circuit. When being located outside the conversion circuit, the rectifier circuit may form part of the light circuit or not.

An embodiment of the conversion circuit is defined by the reactive stage comprising a reactive circuit for reducing an amplitude of one or more of the first and second signals. The first signals are for example currents flowing through the fluorescent ballast, and the second signals are for example currents flowing through the light circuit.

An embodiment of the conversion circuit is defined by the reactive circuit comprising an inductor coupled serially to a part of the input stage and a part of the output stage. An other part of the input stage and an other part of the output stage may be coupled directly. The inductor reduces amplitudes of currents flowing through the fluorescent ballast as well as of currents flowing through the light circuit.

An embodiment of the conversion circuit is defined by the reactive circuit comprising a first inductor coupled serially to a first part of the input stage and a first part of the output stage and a second inductor coupled serially to a second part of the input stage and a second part of the output stage. The inductors reduce amplitudes of currents flowing through the fluorescent ballast as well as of currents flowing through the light circuit.

An embodiment of the conversion circuit is defined by the reactive circuit comprising a capacitor coupled in parallel to the input stage and the output stage. The capacitor reduces amplitudes of currents flowing through the light circuit.

An embodiment of the conversion circuit is defined by the reactive circuit comprising a capacitor coupled in parallel to the input stage and comprising an inductor coupled serially to a part of the input stage and a part of the output stage. This embodiment is a combination of previous embodiments.

An embodiment of the conversion circuit is defined by the at least two inputs comprising four inputs to be coupled to four outputs of the fluorescent ballast, first and second inputs of the four inputs being coupled to each other, and third and fourth inputs of the four inputs being coupled to each other. A (single-lamp) fluorescent ballast usually has four outputs that are to be coupled to the four inputs of the conversion circuit. For example for fluorescent ballasts in the form of self-oscillating ballasts, the first and second inputs of the four inputs can be coupled to each other, and the third and fourth inputs of the four inputs can be coupled to each other. Alternatively, an adaptation circuit may be located between this fluorescent ballast and the conversion circuit, which adaptation circuit takes care of combining the first and second inputs of the four inputs, and of combining the third and fourth inputs of the four inputs. As a result, the conversion circuit then only needs to have two inputs.

An embodiment of the conversion circuit is defined by the at least two inputs comprising four inputs to be coupled to four outputs of the fluorescent ballast, first and second inputs of the four inputs being coupled to each other via a serial connection of first and second resistors, and third and fourth inputs of the four inputs being coupled to each other via a serial connection of third and fourth resistors, a first interconnection between the first and second resistors and a second interconnection between the third and fourth resistors being coupled to the reactive stage. A (single-lamp) fluorescent ballast usually has four outputs that are to be coupled to the four inputs of the conversion circuit. For example for fluorescent ballasts in the form of chip controlled ballasts, the first and second inputs of the four inputs can be coupled to each other via a serial connection of first and second resistors, and the third and fourth inputs of the four inputs can be coupled to each other via a serial connection of third and fourth resistors. Alternatively, an adaptation circuit may be located between this fluorescent ballast and the conversion circuit, which adaptation circuit comprises the four resistors and takes care of combining the first and second inputs of the four inputs, and of combining the third and fourth inputs of the four inputs. As a result, the conversion circuit then only needs to have two inputs.

According to a second aspect, a fluorescent ballast is provided comprising the conversion circuit as defined above.

An embodiment of the fluorescent ballast is defined by the reactive stage comprising a reactive circuit for reducing an amplitude of one or more of the first and second signals, the reactive circuit comprising an inductor coupled serially to a part of the input stage and a part of the output stage, the inductor being located inside the fluorescent ballast or a first part of the inductor being located inside the fluorescent ballast and a second part of the inductor being located outside the fluorescent ballast. When being located outside the fluorescent ballast, the second part of the inductor may be located inside the light circuit or not.

An embodiment of the fluorescent ballast is defined by the reactive stage comprising a reactive circuit for reducing an amplitude of one or more of the first and second signals, the reactive circuit comprising a first inductor coupled serially to a first part of the input stage and a first part of the output stage and a second inductor coupled serially to a second part of the input stage and a second part of the output stage, the first and second inductors being located inside the fluorescent ballast or the first inductor being located inside the fluorescent ballast and the second inductor being located outside the fluorescent ballast. When being located outside the fluorescent ballast, the second inductor may be located inside the light circuit or not.

According to a third aspect, a light circuit is provided comprising the conversion circuit as defined above, the light circuit comprising at least one light emitting diode.

An embodiment of the light circuit is defined by the reactive stage comprising a reactive circuit for reducing an amplitude of one or more of the first and second signals, the reactive circuit comprising an inductor coupled serially to a part of the input stage and a part of the output stage, the inductor being located inside the light circuit or a first part of the inductor being located inside the light circuit and a second part of the inductor being located outside the light circuit. When being located outside the light circuit, the second part of the inductor may be located inside the fluorescent ballast or not.

An embodiment of the light circuit is defined by the reactive stage comprising a reactive circuit for reducing an amplitude of one or more of the first and second signals, the reactive circuit comprising a first inductor coupled serially to a first part of the input stage and a first part of the output stage and a second inductor coupled serially to a second part of the input stage and a second part of the output stage, the first and second inductors being located inside the light circuit or the first inductor being located inside the light circuit and the second inductor being located outside the light circuit. When being located outside the light circuit, the second inductor may be located inside the fluorescent ballast or not.

According to a fourth aspect, a method is provided for replacing a discharge lamp by a light circuit comprising at least one light emitting diode, the method comprising a step of installing a conversion circuit as defined above between a fluorescent ballast and the light circuit.

An insight could be that complexity is to be reduced. A basic idea could be that the conversion circuit should comprise an input stage with at least two inputs, an output stage with two outputs, and a reactive stage for coupling the output stage to the input stage.

A problem to provide an improved conversion circuit that is relatively simple has been solved. A further advantage could be that the conversion circuit is relatively low-cost and relatively robust.

These and other aspects of the invention will be apparent from and elucidated with reference to the embodiments described hereinafter.

### BRIEF DESCRIPTION OF THE DRAWINGS

In the drawings:

FIG. 1 shows a mains input, a prior art fluorescent ballast and a discharge lamp,

FIG. 2 shows a prior art fluorescent ballast in greater detail,

FIG. 3 shows a fluorescent ballast, a conversion circuit and a light circuit as separate modules,

FIG. 4 shows a fluorescent ballast and a light circuit as separate modules, the fluorescent ballast comprising a conversion circuit,

FIG. 5 shows a fluorescent ballast and a light circuit as separate modules, the light circuit comprising a conversion circuit,

FIG. 6 shows a fluorescent ballast and a light circuit as separate modules, the fluorescent ballast and the light circuit each comprising a part of a conversion circuit,

FIG. 7 shows a conversion circuit in greater detail,

FIG. 8 shows a first embodiment of a conversion circuit,

FIG. 9 shows a second embodiment of a conversion circuit,

FIG. 10 shows a third embodiment of a conversion circuit, and

FIG. 11 shows a power value versus inductance value graph.

### DETAILED DESCRIPTION OF EMBODIMENTS

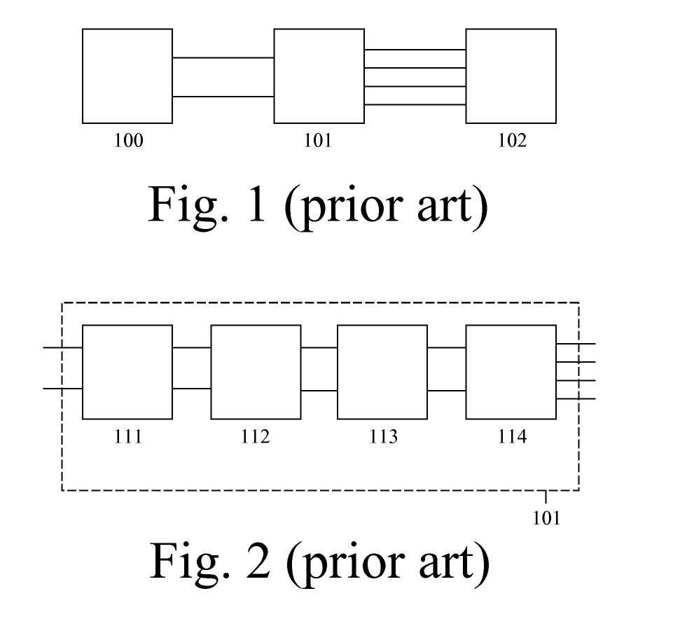

In the FIG. 1, a mains input 100, a prior art fluorescent ballast 101 and a discharge lamp 102 are shown. Two outputs of the mains input 100 are coupled to two inputs of the fluorescent ballast 101, and four outputs of the fluorescent ballast 101 are coupled to four inputs of the discharge lamp 102.

In the FIG. 2, a prior art fluorescent ballast 101 is shown in greater detail. The fluorescent ballast 101 comprises for example an electro magnetic induction filter 111, a rectifier 112, a power factor corrector 113 and a half bridge 114 including a resonant tank.

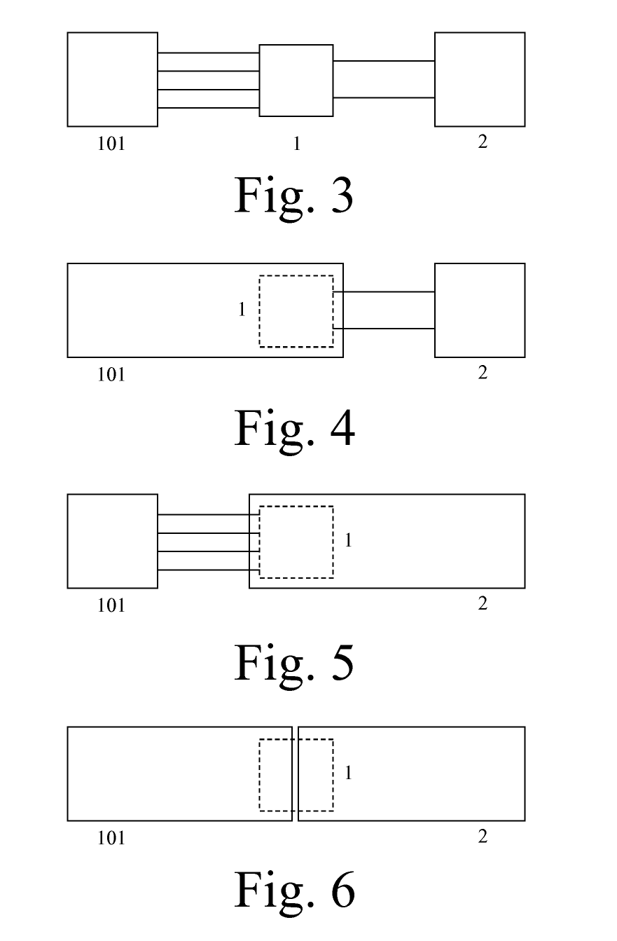

In the FIG. 3, a fluorescent ballast 101, a conversion circuit 1 and a light circuit 2 are shown as separate modules. The light circuit 2 comprises one or more light emitting diodes of whatever kind and in whatever combination.

In the FIG. 4, a fluorescent ballast 101 and a light circuit 2 are shown as separate modules, the fluorescent ballast 101 now comprising a conversion circuit 1.

In the FIG. 5, a fluorescent ballast 101 and a light circuit 2 are shown as separate modules, the light circuit 2 now comprising a conversion circuit 1.

In the FIG. 6, a fluorescent ballast 101 and a light circuit 2 are shown as separate modules, the fluorescent ballast 101 and the light circuit 2 each comprising a part of a conversion circuit 1.

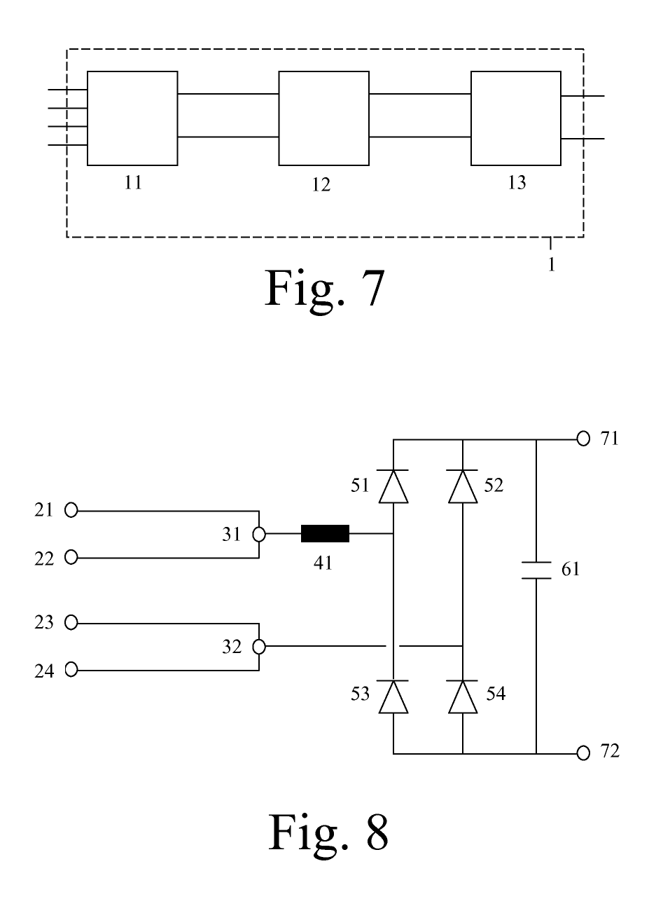

In the FIG. 7, a conversion circuit 1 is shown in greater detail. The conversion circuit 1 comprises an input stage 11, a reactive stage 12 and an output stage 13. Here, the input stage 11 comprises four inputs, but alternatively it may comprise two inputs in which case an adaptation circuit with four inputs and two outputs may need to be introduced between the fluorescent ballast 101 and the input stage 11. In case the fluorescent ballast 101 and the light circuit 2 each comprise a part of the conversion circuit 1, as shown in the FIG. 6, the input stage 11 may form part of the fluorescent ballast 101 and the output stage 13 may form part of the light circuit 2 and the reactive stage 12 may form part of the fluorescent ballast 101 or of the light circuit 2, or a first part of the reactive stage 12 may form part of the fluorescent ballast 101 and a second part of the reactive stage 12 may form part of the light circuit 2.

In the FIG. 8, a first embodiment of a conversion circuit 1 is shown. Two inputs 21 and 22 are coupled to each other to create an interconnection 31, and two inputs 23 and 24 are coupled to each other to create an interconnection 32. The interconnection 31 is coupled via a first inductor 41 to an anode of a diode 51 and to a cathode of a diode 53. The interconnection 32 is coupled to an anode of a diode 52 and to a cathode of a diode 54. Cathodes of the diodes 51 and 52 are coupled to an output 71, and anodes of the diodes 53 and 54 are coupled to an output 72. A filtering capacitor 61 for filtering a high frequency ripple signal is coupled to both outputs 71 and 72. A first part of the first inductor 41 may be located inside the conversion circuit 1 and a second part of the first inductor 41 may be located outside the conversion circuit 1, for example inside the light circuit 2.

In view of the FIGS. 7 and 8, the inputs 21-24 and the interconnections 31 and 32 are for example parts of the input stage 11. The first inductor 41 is for example a part of the reactive stage 12. And the diodes 51-54 and the filtering capacitor 61 and the outputs 71 and 72 are for example parts of the output stage 13. Firstly, alternatively, the inputs 21 and 22 as coupled to each other and the inputs 23 and 24 as coupled to each other may be located outside the input stage 11 and may form part of an adaptation circuit not shown, with the interconnection 31 as coupled to said inputs 21 and 22 and the interconnection 32 as coupled to said inputs 23 and 24 being inputs of the input stage 11. Secondly, alternatively, the diodes 51-54 and/or the filtering capacitor 61 may be located outside the output stage 13 and may be located in a separate module between the output stage 13 and the light circuit 2 or may be located inside the light circuit 2.

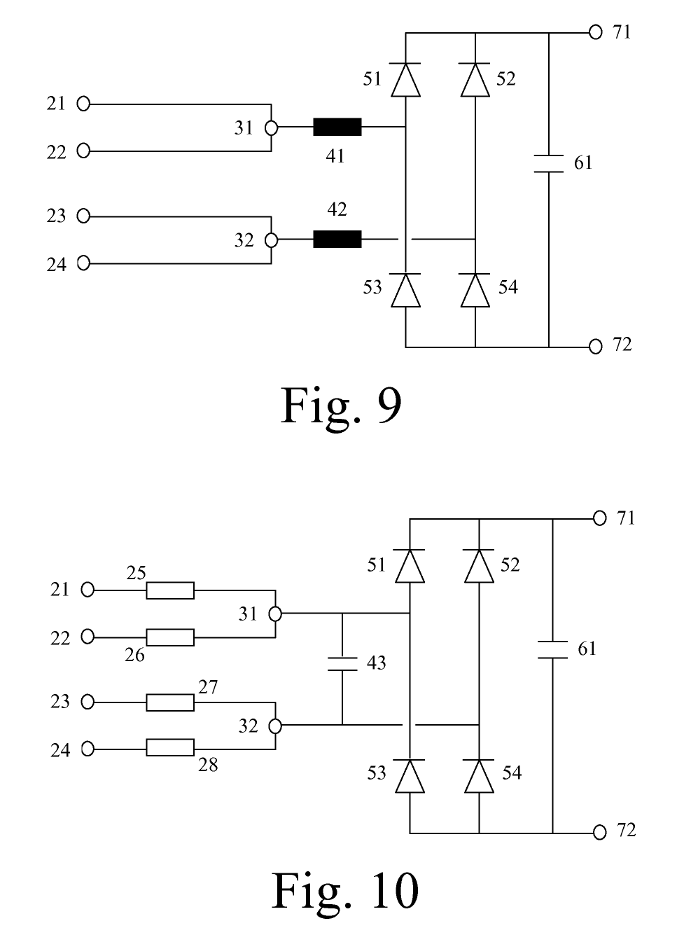

In the FIG. 9, a second embodiment of a conversion circuit 1 is shown, that only differs from the first embodiment in that the interconnection 32 and the diodes 52 and 54 are now coupled to each other via a second inductor 42. Both inductors 41 and 42 may be inductively coupled or not. Both inductors 41 and 42 may be located inside the conversion circuit 1 or one of them may be located inside the conversion circuit 1 and the other one may be located outside the conversion circuit 1, for example inside the light circuit 2.

The first and second embodiments shown in the FIGS. 8 and 9 are for example related to fluorescent ballasts 101 in the form of self-oscillating ballasts. For this kind of ballasts it is allowed to connect first and second outputs of the fluorescent ballast to each other and to connect third and fourth outputs of the fluorescent ballast to each other.

In the FIG. 10, a third embodiment of a conversion circuit 1 is shown. Two inputs 21 and 22 are coupled to each other via serial resistors 25 and 26 to create an interconnection 31, and two inputs 23 and 24 are coupled to each other via serial resistors 27 and 28 to create an interconnection 32. The interconnections 31 and 32 are coupled to each other via a capacitor 43. The interconnection 31 is coupled to an anode of a diode 51 and to a cathode of a diode 53. The interconnection 32 is coupled to an anode of a diode 52 and to a cathode of a diode 54. Cathodes of the diodes 51 and 52 are coupled to an output 71, and anodes of the diodes 53 and 54 are coupled to an output 72. A filtering capacitor 61 for filtering a high frequency ripple signal is coupled to both outputs 71 and 72.

In view of the FIGS. 7 and 10, the inputs 21-24 and the resistors 25-28 and the interconnections 31 and 32 are for example parts of the input stage 11. The capacitor 43 is for example a part of the reactive stage 12. And the diodes 51-54 and the filtering capacitor 61 and the outputs 71 and 72 are for example parts of the output stage 13. Firstly, alternatively, the inputs 21-24 and the resistors 25-28 may be located outside the input stage 11 and may form part of an adaptation circuit not shown, with the interconnections 31 and 32 being inputs of the input stage 11. Secondly, alternatively, the diodes 51-54 and/or the filtering capacitor 61 may be located outside the output stage 13 and may be located in a separate module between the output stage 13 and the light circuit 2 or may be located inside the light circuit 2.

The third embodiment shown in the FIG. 10 is for example related to fluorescent ballasts 101 in the form of fixed frequency ballasts (the fixed frequency being a frequency in a steady state) and chip controlled ballasts. For this kind of ballasts, that typically have filament heating transformers inside the ballasts, it is usually not allowed to connect first and second outputs of the fluorescent ballast to each other and to connect third and fourth outputs of the fluorescent ballast to each other. Instead of that, some resistance needs to be introduced between the first and second outputs of the fluorescent ballast and between the third and fourth outputs of the fluorescent ballast to prevent overloading of the heating transformer inside the fluorescent ballast.

Each part of each one of the first and second embodiments may be combined with each part of the third embodiment, whereby the capacitor 43 will be used for coupling the interconnections 31 and 32 and whereby the inductor 41 (42) will be used for coupling the interconnection 31 (32) to the diodes 51 and 53 (52 and 54).

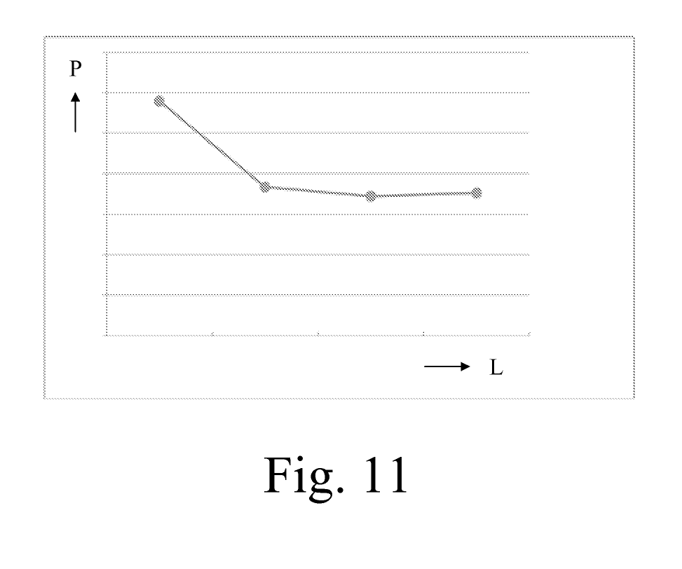

In the FIG. 11, a power (P) value versus inductance (L) value graph is shown. For relatively small and increasing inductance values of the first inductor 41, decreasing power values for the light circuit 2 are found. For relatively large and increasing inductance values of the first inductor 41, relatively stable power values for the light circuit 2 are found.

Summarizing, conversion circuits 1 convert first signals coming from fluorescent ballasts 101 into second signals for light circuits 2 comprising light emitting diodes to replace discharge lamps 102. The conversion circuits 1 comprise input stages 11 with at least two inputs 21-24, 31-32 for receiving the first signals, output stages 13 with two outputs 71-72 for supplying the second signals, and reactive stages 12 for coupling the input and output stages 11, 13. Such relatively simple conversion circuits 1 are relatively low-cost and relatively robust. The reactive stages 12 comprise reactive circuits and reduce amplitudes of one or more of the first and second signals. The reactive circuits comprise one or more inductors 41, 42 and/or capacitors 43. The conversion circuits 1 may form part of the fluorescent ballasts 101 or may form part of the light circuits 2 or may partly form part of the fluorescent ballasts 101 and may partly form part of the light circuits 2.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A conversion circuit for converting first signals coming from a fluorescent ballast into second signals for feeding a light circuit, the light circuit comprising at least one light emitting diode, the conversion circuit comprising:
an input stage with at least two inputs for receiving the first signals;
a reactive stage for coupling the output stage to the input stage and configured to reduce an amplitude of one or more of the first signals,
an output stage with two outputs for supplying the second signals, wherein the conversion circuit further comprising a high frequency filter at the output stage.

2. The conversion circuit as defined in claim 1, the high frequency filter comprising a capacitor coupled between both outputs.

3. The conversion circuit as defined in claim 1, the reactive circuit comprising an inductor coupled serially to a part of the input stage and a part of the output stage.

4. The conversion circuit as defined in claim 1, the reactive circuit comprising a first inductor coupled serially to a first part of the input stage and a first part of the output stage and a second inductor coupled serially to a second part of the input stage and a second part of the output stage.

5. The conversion circuit as defined in claim 1, the reactive circuit comprising a capacitor coupled in parallel to the input stage and the output stage.

6. The conversion circuit as defined in claim 1, the reactive circuit comprising a capacitor coupled in parallel to the input stage and comprising an inductor coupled serially to a part of the input stage and a part of the output stage.

7. The conversion circuit as defined in claim 1, the at least two inputs comprising four inputs to be coupled to four outputs of the fluorescent ballast, first and second inputs of the four inputs being coupled to each other, and third and fourth inputs of the four inputs being coupled to each other.

8. The conversion circuit as defined in claim 1, the at least two inputs comprising our inputs to be coupled to four outputs of the fluorescent ballast, first and second inputs of the four inputs being coupled to each other via a serial connection of first and second resistors, and third and fourth inputs of the four inputs being coupled to each other via a serial connection of third and fourth resistors, a first interconnection between the first and second resistors and a second interconnection between the third and fourth resistors being coupled to the reactive stage.

9. A fluorescent ballast comprising the conversion circuit as defined in claim 1.

10. The fluorescent ballast as defined in claim 9, the reactive stage comprising a reactive circuit for reducing an amplitude of one or more of the first and second signals, the reactive circuit comprising an inductor coupled serially to a part of the input stage and a part of the output stage, the inductor being located inside the fluorescent ballast or a first part of the inductor being located inside the fluorescent ballast and a second part of the inductor being located outside the fluorescent ballast.

11. The fluorescent ballast as defined in claim 9, the reactive stage comprising a reactive circuit for reducing an amplitude of one or more of the first and second signals, the reactive circuit comprising a first inductor coupled serially to a first part of the input stage and a first part of the output stage and a second inductor coupled serially to a second part of the input stage and a second part of the output stage, the first and second inductors being located inside the fluorescent ballast or the first inductor being located inside the fluorescent ballast and the second inductor being located outside the fluorescent ballast.

12. A light circuit comprising the conversion circuit as defined in claim 1, the light circuit comprising at least one light emitting diode.

13. The light circuit as defined in claim 12, the reactive stage comprising a reactive circuit for reducing an amplitude of one or more of the first and second signals, the reactive circuit comprising an inductor coupled serially to a part of the input stage and a part of the output stage, the inductor being located inside the light circuit or a first part of the inductor being located inside the light circuit and a second part of the inductor being located outside the light circuit.

14. The light circuit as defined in claim 12, the reactive stage comprising a reactive circuit for reducing an amplitude of one or more of the first and second signals, the reactive circuit comprising a first inductor coupled serially to a first part of the input stage and a first part of the output stage and a second inductor coupled serially to a second part of the input stage and a second part of the output stage, the first and second inductors being located inside the light circuit or the first inductor being located inside the light circuit and the second inductor being located outside the light circuit.

15. A method for replacing a discharge lamp by a light circuit comprising at least one light emitting diode, the method comprising a step of installing a conversion circuit as defined in claim 1 between a fluorescent ballast and the light circuit.
